(19) United States
(12) Patent Application Publication
(10) Pub. No.: US 2011/0214491 A1
(43) Pub. Date: Sep. 8, 2011

(54) GLASS MAT SLURRY BLEED THROUGH EMULATOR

(76) Inventors: Renee Jane Weinberger, Waukegan, IL (US); Christopher Nelson, Lindenburst, IL (US); Michael Patrick Shake, Johnsburg, IL (US)

(21) Appl. No.: 12/717,761

(22) Filed: Mar. 4, 2010

(51) Int. Cl. G01N 5/02

(52) U.S. Cl. 73/73

(57) ABSTRACT

A method for testing fluid flow-through through a fabric includes providing a sample of fabric and placing the fabric upon an open upper end of a sample retainer having a receptacle with an upper end configured for securing a sample of the fabric, and having a surface spaced below the sample, placing a fluid injector a predetermined distance above the sample retainer, the fluid injector having a reservoir of fluid and an outlet configured for directing fluid directly upon the sample, and directing the fluid upon the sample and measuring at least one of the linear displacement of the fluid upon the sample, the time for the fluid to pass directly through the sample and the total volume of fluid passing through the sample measured by the amount of fluid retained on the surface.

### BACKGROUND

The present invention relates generally to devices and techniques for testing the resistance of paper or similar water absorbent webs to fluid bleed through, and more specifically to a test apparatus and method for predicting fluid bleed through for fiberglass matrices.

Conventional tests for fluid or water absorption applied to fabrics include the Cobb tests (Tappi: T441), the Contact Angle test (T498), the Water Drop Absorption test (Tappi Useful Method 415), the Boiling Boat test (Tappi Useful Method 543), and the Dynamic Angle test, the latter performed such that the angle the water droplet makes with the test fabric or paper is measured. Specifically, in highly water absorbent paper, the water droplet becomes flattened over time, appearing like a gently sloping hill, so that an obtuse angle is defined. In highly water resistant paper, the droplet rests upon the top of the paper like sphere, and defines an acute angle. Such tests and other known water/fluid absorption tests measure, among other things, the volume of retained fluid or are intended for use in testing fabric care products.

Accordingly, these tests are not particularly suitable for testing construction-grade fabrics used in producing construction board from a settable slurry forming the core which is sandwiched between layers of facing material. Moreover, the conventional tests have proven unsuitable for providing useful information for fiberglass matrices, particularly of the type used for facing layers of construction board wherein a pair of such layers sandwich a settable slurry such as gypsum, cement or combinations of same. Such fiberglass fabrics are more water resistant, have different capillary action properties and do not bond with Hydrogen atoms in the same way.

Thus, when applied to fiberglass fabrics, the conventional tests provide inferior and inaccurate results. One distinctive property of fiberglass compared to paper is that individual fiberglass fibers do not absorb water, compared to paper fibers. Instead, the water just beads up on the fibers. However, a fabric (woven or nonwoven) of such fiberglass fibers will retain water due to the water droplets becoming trapped in the fiber matrix.

The interest in such bleed through tests in manufacturing construction board is that facing fabrics including or made exclusively of fiberglass or other nonwoven water impermeable fibers in some cases allow full penetration or “bleed through” of the settable slurry contained between the layers of fabric. Such bleed through is considered an undesirable occurrence and detracts from the appearance of the final construction board product. Thus, there is an interest in providing a test scenario in which such potential water resistant or impermeable fabrics are tested for their bleed through properties.

### SUMMARY

A test system provides a controlled scenario for applying fluid to water resistant matrix fabric such as fiberglass that allows quantified study of the fluid absorbent properties of such fabrics. Obstacles encountered in prior art testing devices have been overcome. Specifically, the drawbacks of interminable fluid penetration and complete obliteration of water resistance, due to excessive volumes applied to the fabric during testing, have been significantly reduced. Instead, the fluid flow through is achieved by providing the fluid at a sufficient velocity for measuring flow through performance, while avoiding excessive flow through of fluid which is not helpful in evaluating the fabric, since at higher velocities, all fluid will penetrate and flow through the fabric.

An apparatus is provided for securely retaining a sample web or matrix of absorbent media. A fluid injector device is disposed a predetermined distance above the sample retainer for dispensing the fluid at a predetermined velocity and volume. A velocity of fluid is directed upon the sample surface sufficient to cause a forced flow-through through which at least one of continued fluid penetration and surface fluid spread, quantity of fluid penetration and time until breach of fluid is observed. Below the fluid injector, the device includes a sample holder that secures the sample fabric, allows water to enter from the top, wick through the sample and becomes captured in a receptacle beneath the sample.

In the present system, the time from the beginning of the test until the fluid emerges through the sample is measured. Also, the linear spread of the fluid on the sample is measured and defined. In addition, the weight of the absorbent fabric material in the sample retainer is measured before and after the test. Optionally, the weight of the fluid passing through the sample is monitored.

More specifically, a test apparatus for monitoring passage of fluid through a fabric includes a fluid injector including a chamber retaining a predetermined volume of fluid and having an outlet, the injector configured for providing a predetermined volume of fluid at a predetermined velocity, a sample retainer located beneath the injector and including a receptacle with an upper end configured for securing a sample of the fabric, and having a surface spaced below the sample, the injector being disposed a predetermined distance above the upper end of the retainer for generating a sufficient force of fluid sufficient to pass through the sample and for being measured on the surface.

In another embodiment, a method for testing fluid flow-through through a fabric includes providing a sample of fabric and placing the fabric upon an open upper end of a sample retainer having a receptacle with an upper end configured for securing a sample of the fabric, and having a surface spaced below the sample, placing a fluid injector a predetermined distance above the sample retainer, the fluid injector having a reservoir of fluid and an outlet configured for directing fluid directly upon the sample, and directing the fluid upon the sample and measuring at least one of the linear displacement of the fluid upon the sample, the time for the fluid to pass directly through the sample and the total volume of fluid passing through the sample measured by the amount of fluid retained on the surface.

### BRIEF DESCRIPTION OF THE DRAWINGS

FIG. 1 is a top perspective view of the present test apparatus;

FIG. 2 is an enlarged top perspective view of several samples mounted on sample retainers and depicting the spread of test fluid on the samples;

FIG. 3 is an overhead plan view of a single sample illustrating the amount of radial spread of the fluid; and

FIG. 4 is a side elevation in partial vertical section of the present sample retainer depicting the visual test for fluid penetration.

### DETAILED DESCRIPTION OF THE INVENTION

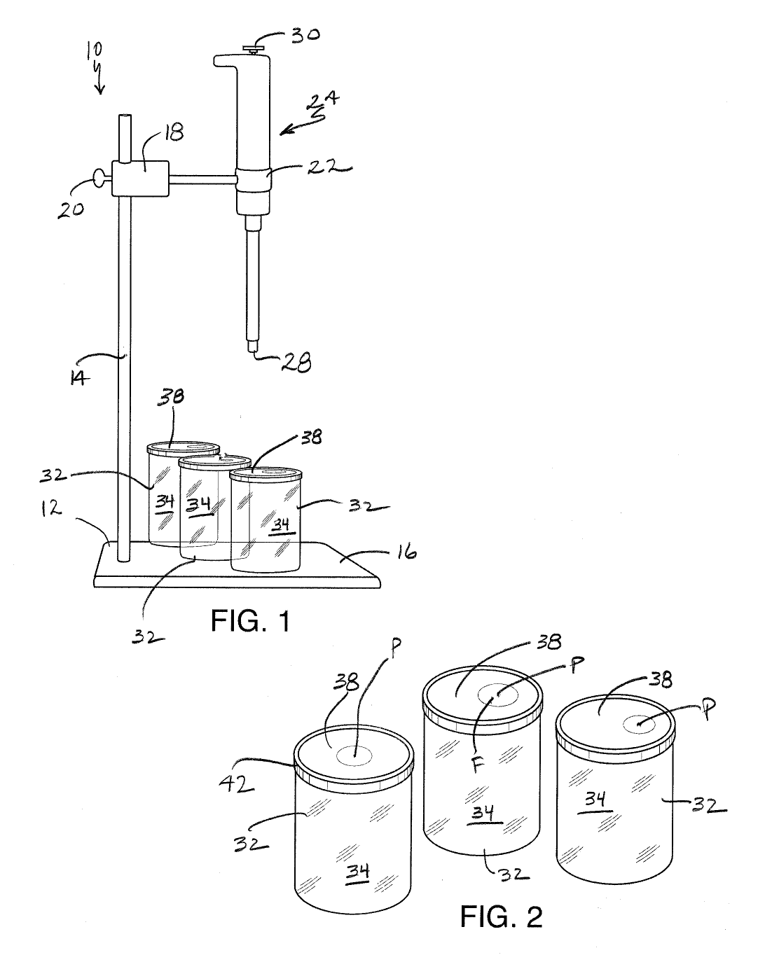

Referring now to FIGS. 1 and 4, the present test apparatus or bleed through emulator is generally designated 10, and is designed for testing the fluid bleed through of fabrics, particularly nonwoven fiberglass fabrics made of water impermeable fibers, which when the fibers are made into the fabrics, the fabrics develop water retentive properties. The apparatus 10 includes a support stand 12 which may assume various configurations, but in an exemplary form includes a vertical support post 14 anchored to a base 16 as is known in the laboratory art, or alternatively to a work surface.

Upon the vertical support post 14 is mounted an adjustable clamp 18 having an adjustable fastener 20 such as a thumbscrew for vertically adjusting the clamp relative to the post 14. Also as is known in the art, the clamp 18 has adjustable jaws 22 for securely retaining a fluid injector, generally designated 24 including a chamber 26 (FIG. 4) retaining a predetermined volume of fluid ‘F’ and having an outlet 28 configured such that the injector providing a predetermined volume of fluid at a predetermined velocity. In the preferred embodiment, the fluid ‘F’ is water, however other fluids are contemplated depending on the application. Also, in the present application, the terms ‘fluid’ and ‘water’ are deemed interchangeable. It is preferred that the fluid injector 24 is a dispensing pipette of the type manufactured by Eppendorf (www.eppendorfna.com) (offices located worldwide) or equivalent devices known in the art. It is also preferred that the injector 24 is configured so that the chamber 26 is open to ambient to allow for gravity flow of fluid from the outlet 28. A control button or valve 30 is actuated by the user to release a specified volume of the fluid ‘F’. In the present application, the volume of the fluid ‘F’ is preferably in the range of 2 milliliters (mils), the result of actuating the button 30 for approximately 2.3 seconds.

Also included in the apparatus 10 is a sample retainer, generally designated 32 located beneath the fluid injector 24 and including a receptacle 34 with an open upper end or mouth 36 configured for securing a sample 38 of the fabric, and having a surface 40 spaced below the sample (FIG. 4). A suitable sample 38 is a sheet of fiberglass fabric having a thickness of approximately 10-15 microinches (254-381 nanometers).

The surface 40 is preferably secured to the retainer 32 so as to prevent the escape of fluid reaching the surface. A suitable sample retainer 32 is a wide mouthed jar, such as those used in canning fruits or vegetables; however other such containers are deemed acceptable depending on the application. In that case, the surface 40 is the bottom of the jar. A sample retaining device 42 such as a clamping ring engages the open upper end 36, as by threading or the like so that the sample 38 is releasably retained on the upper end in a stretched or taught disposition. Other suitable clamping devices are contemplated for holding the sample 38 in position.

The fluid injector 24 is disposed a predetermined distance ‘D’ (FIG. 4) above the upper end 36 of the sample retainer 32 for generating a sufficient force of the fluid ‘F’ sufficient to impact the sample 38 to linearly spread in a measurable manner, and eventually to pass through the sample. Optionally, the weight of the fluid ‘F’ is measurable on the surface 40. While other distances ‘D’ are contemplated depending on the application, the type of injector 24 and the type of sample 38 being tested, in the preferred embodiment, the outlet 28 is located approximately 6 inches (15 cm) above the upper end 36. In addition, it is preferred that the outlet 28 be disposed relative to the sample retainer 32 so that the emitted fluid ‘F’ flows directly upon the sample retainer such that the sample 38 is oriented at a 90° angle to the flow of fluid. In other words, the emitted fluid ‘F’ flows vertically from the outlet 28 directly upon the sample 38.

Once the apparatus 10 is filled with the fluid ‘F’ and a sample 38 of fabric is securely positioned on the sample retainer 32 using the sample retaining device 42, a test scenario is conducted wherein fluid is released from the outlet 28 of the fluid injector 24 and travels the distance ‘ID’ to directly and vertically impact the sample.

At least one of the linear displacement of the fluid ‘F’ upon the sample 38, the time for the fluid to pass directly through the sample and the total volume of fluid passing through the sample measured by the amount of fluid retained on the surface are measured.

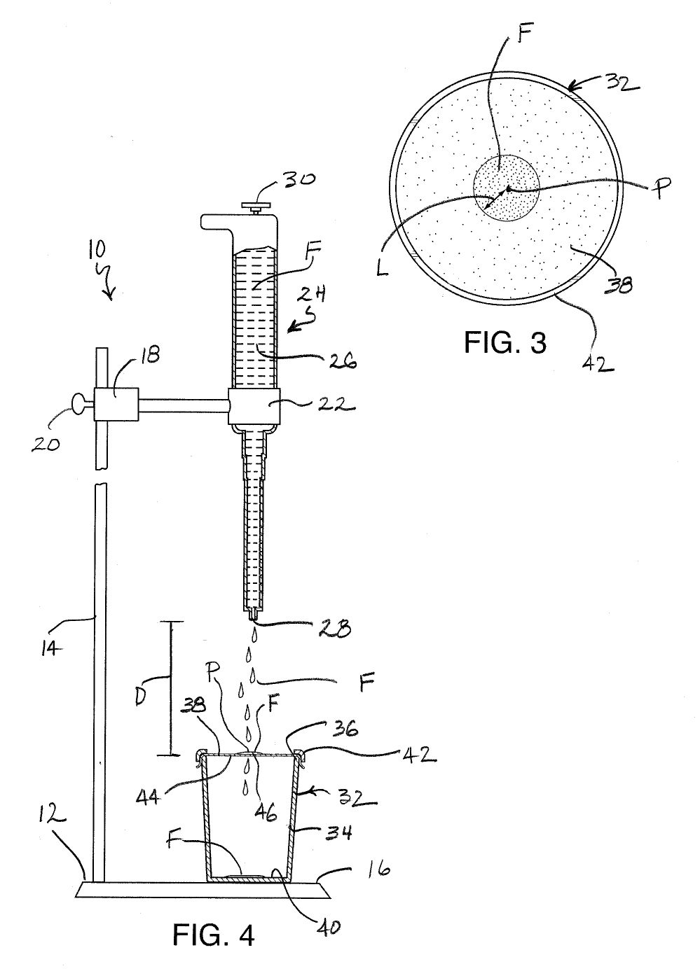

Referring now to FIGS. 2 and 3, the linear displacement ‘L’ of the fluid upon the sample 38 is measured from the point of impact ‘P’ of the fluid upon the sample and to the farthest linear distance from the point ‘P’. A suitable measuring device, such as a pair of calipers, is used for measuring the displacement ‘L.’ It is preferred that the emitted fluid ‘F’ be dropped vertically upon the sample 38 so that a reproducible impact point P is obtained, and that the resulting linear spread of the fluid on the sample forms a generally uniform circle (FIG. 3). In this manner, multiple data points of the displacement I′ can be obtained to provide more accurate evaluation of the sample 38. The volume of fluid ‘F’ emitted and the distance ‘D’ are determined to prevent the wholesale flow through of fluid through the sample 38, which would impair proper evaluation of the desired “bleed through” characteristics.

Referring now to FIG. 4, in addition, the time for the fluid ‘F’ to pass through the sample 38 is optionally measured from the first release of fluid from the injector outlet 28 until fluid is visually observed dripping from an underside 44 of the sample. As seen in FIG. 4, upon impacting the sample 38, the fluid ‘F’ forms a generally hemispherical bead 46 prior to dispersing in the fabric sample. Furthermore, the total volume of fluid passing through the sample 38 is measured by collecting and weighing the fluid residue found on the surface 40. Such fluid residue is collected by known techniques such as micropipettes and suction, among others. A contemplated alternative is the use of blotting paper on the surface 40, which is weighed before and after the fluid flows upon it to determine the amount of fluid passing through the sample 38.

Thus, it will be seen that the present bleed through emulator 10 addresses and overcomes the drawbacks of prior art fabric testing devices and methods, and is particularly suitable for use with nonwoven fiberglass fabrics of the type used as facing material on construction boards. Use of the present apparatus in practicing the present method provides a more accurate way for selecting appropriate facing materials.

While a particular embodiment of the present fabric bleed through emulator has been described herein, it will be appreciated by those skilled in the art that changes and modifications may be made thereto without departing from the invention in its broader aspects and as set forth in the following claims.

1. A test apparatus for monitoring passage of fluid through a fabric, comprising:
a fluid injector including a chamber retaining a predetermined volume of fluid and having an outlet, said injector configured for providing a predetermined volume of fluid at a predetermined velocity;
a sample retainer located beneath said injector and including a receptacle with an upper end configured for securing a sample of the fabric, and having a surface spaced below the sample;
said injector being disposed a predetermined distance above said upper end of said retainer for generating a sufficient force of fluid sufficient to pass through the sample and for being measured on said surface.

2. The apparatus of claim 1 wherein said injector is disposed approximately 6 inches (15 cm) from said upper end.

3. The apparatus of claim 1 wherein said injector is disposed above said sample retainer so that the emitted fluid flows directly upon said sample retainer such that said sample is at a 90° angle to the flow of fluid.

4. The apparatus of claim 1 wherein said injector chamber is open to atmosphere such that the fluid flows by gravity upon the sample.

5. The apparatus of claim 1 wherein the sample is releasably retained upon said retainer, and is held taught upon said upper end.

6. The apparatus of claim 1 wherein said injector is disposed above the sample retainer to provide a point of fluid impact, from which the fluid radially spreads a measurable distance.

7. A method for testing fluid flow-through through a fabric, comprising:
providing a sample of fabric and placing the fabric upon an open upper end of a sample retainer having a receptacle with an upper end configured for securing a sample of the fabric, and having a surface spaced below the sample;
placing a fluid injector a predetermined distance above the sample retainer, the fluid injector having a reservoir of fluid and an outlet configured for directing fluid directly upon the sample; and
directing the fluid upon the sample and measuring at least one of the linear displacement of the fluid upon the sample, the time for the fluid to pass directly through the sample and the total volume of fluid passing through the sample measured by the amount of fluid retained on the surface.

8. The method of claim 7 wherein said fluid injector is disposed approximately 6 inches (15 cm) above the sample.

9. The method of claim 7 wherein the linear displacement of the fluid upon the sample is measured from a point of impact of the fluid upon the sample and to the farthest linear distance from the point.

10. The method of claim 7 wherein the time for the fluid to pass through the sample is measured from the first release of fluid from the injector outlet until fluid is visually observed dripping from an underside of the sample.

11. The method of claim 7 further including positioning the injector above the sample retainer so that the sample is at a 90° angle to the flow of fluid.

12. The method of claim 7 wherein the total volume of fluid passing through the sample is measured by collecting and weighing a fluid residue found on the surface.
